(19) United States
(12) Patent Application Publication
(10) Pub. No.: US 2006/0173732 A1
(43) Pub. Date: Aug. 3, 2006

(54) METHOD OF COLLABORATIVELY SOLVING A PROBLEM

(76) Inventor: Gerald Edwards, Sayville, NY (US)

Correspondence Address: STANLEY H. KREMEN, 4 LENAPE LANE, EAST BRUNSWICK, NJ, 08816, US

(21) Appl. No.: 11/381,123

(22) Filed: May 1, 2006

Related U.S. Application Data
(60) Provisional application No. 60/743,325, filed on Feb. 21, 2006.

(51) Int. Cl. G07C 13/00

(52) U.S. Cl. 705/12

(57) ABSTRACT

A method of collaboratively solving a problem by holding group meetings. The group comprises members each being given equal status, a problem expert, a facilitator, and a scribe. The problem expert initially explains the problem to the group. Afterwards, he or she is available for questions from the group regarding the problem described, but is not permitted to propose solutions to the problem. Only after the group (exclusive of the problem expert) arrives at a viable solution will the problem expert participate in evaluating the effectiveness of the proposed. The problem expert rates the plan according to a scale. Only after the problem expert rates the plan at the top of the scale does his or her function as problem expert end. The problem expert then joins the team as a member to complete the rest of the plan. Meetings may be conducted either with or without the use of a computer to pace the meeting and to determine the order of business.

### CROSS REFERENCE TO RELATED APPLICATIONS

This Application is a non-provisional counterpart and claiming benefit of U.S. Provisional Application Ser. No. 60/743,325, filed Feb. 21, 2006.

### BACKGROUND OF THE INVENTION

Traditionally, problems in organizations, ranging from small to large, are solved using a team approach. Once a problem is identified, the organization usually assigns a group to develop the solution. The group meets from once to several times. Often this approach yields a reasonable solution to the problem. However, more often, the solution developed by the group is flawed. The organization implements the solution, and the solution fails to completely solve the problem. The solution is then modified one or more times until the organization exhausts its monetary and manpower resources that can be allocated to the problem. From that point, an imperfect solution is implemented or the entire project is scrapped. The basic paradigm is that problems are either solved or forgotten.

The traditional team approach generally fails for the following reasons: there generally exists a lack of understanding or clarification of the problem: global/specifics;
there is an inability to focus or concentrate on the problem;
there is a failure to follow a systematic comprehensive procedure;
the meeting is often dominated by a few individuals (chairman/boss, etc.), and the need for change is often interpreted by the boss as incompetence on his or her part—hence there is a resistance to change;
there is a fear of punishment if some members of the team speak openly;
there is often competition among the members that prevents cooperation;
the members are often unable to work together as a team;
negative attitudes often form due to:

[symbol] put-downs, withdrawals, or attacks;

[symbol] the formation of subgroups (allies vs. adversaries); or,

[symbol] diversionary tactics;
too much knowledge of what does not work often prevents speculation or exploration of ideas;
responses such as, “Yeah, but . . . ,” and “What if . . . ,” are negative forms which develop negative energy that drains the group; and,
people generally cannot separate ideas presented from self-concept. They are an extension of “self.” Therefore, rejection of an idea is tantamount to rejection of the person presenting the idea.

FIG. 1 is a schematic diagram of the traditional team that meets to solve a problem. While all members of the team become somewhat familiar with the details of the problem, each individual's expertise causes the team members to interpret the problem differently. This could be positive if the team works together, but caucuses generally form that prevent all of the members of the team from contributing freely. When a solution is finally developed, it is achieved through a series of compromises among group members. This leads to development of a mediocre solution having a high failure probability.

Where there is disagreement among the members of a team, a meeting can become unruly and disorganized. This type of chaotic meeting works against developing a solution to the problem. Also, members of the team having a lower rank or status often tend to become disenfranchised, leading to a solution favoring the more powerful members. Solutions to this problem have been implemented over the years by the introduction of parliamentary procedure. For example, Robert's Rules of Order were developed to prevent disenfranchisement of minority members of an organization. These rules are adequate for governmental bodies and political and membership organizations. However, this method of running a meeting is not conducive to developing solutions for most problems facing business organizations.

For groups to succeed, the members of the group need to feel that:
1. they are worthwhile contributors; and,
2. they have accomplished the task presented.
   They do not want to feel that they are “spinning their wheels” endlessly.

George M. Prince, in his book, “The Practice of Creativity,” proposes that in a meeting, direct negative criticism of one member's ideas by another member of the team should be discouraged. Instead, when one member offers an idea or solution, the other members should first look to the positive aspects of the suggestion, and only then should they voice concerns about its implementation. He labels this concept as the “Spectrum Policy.” This is an exemplary concept, and it should be implemented. However, this concept standing alone does not create the atmosphere required to prevent the group from failing to achieve its objectives. When a person hears another team member say: “I like your idea because . . . , but I am concerned about . . . ,” the only thing he or she remembers is the phrase beginning with “but.” For example, when a judge pronounces his or her decision on a weighty matter before the court, he or she almost always begins with the arguments supporting the losing side and ends with the arguments supporting the winning side. As the judge begins to pronounce his or her decision, everyone knows what its outcome will be once the judge begins to speak. The winning side always follows the word “but.”

Prince also suggests that the person with the most experience with the problem (i.e., the problem expert) should be the leader of the group. According to Prince, the role of the problem expert as leader:
1. proves that he is there to find ideas that will work;
2. proves that he is not going to build his ego at the expense of group members' suggestions;
3. indicates the sort of direction that will be acceptable (when other directions arise, he will recognize them, also);
4. proves that he will listen;
5. builds on what was suggested; and,
6. helps the team to understand more about the problem.

The difficulty with this approach is that it pre-supposes that the problem expert will not try to dominate the meeting by imposing pre-conceived solutions on the group. While Prince criticizes the way group problem solving meetings are organized, his proposed solution presumes an idealized relationship between the group leader and the participants. For the most part, this idealized relationship does not exist.

Therefore, there is a need for a method of collaboratively solving a problem by holding group meetings wherein the group dynamics actually promote development of the solution.

### SUMMARY OF THE INVENTION

Disclosed herein is a method of collaboratively solving a problem by holding group meetings. The group comprises members each being given equal status, a problem expert, a facilitator, and a scribe. The problem expert initially explains the problem to the group. Afterwards, he or she is available for questions from the group regarding the problem described, but is not permitted to propose solutions to the problem. Only after the group (exclusive of the problem expert) arrives at a viable solution is the problem expert permitted to participate in evaluating the effectiveness of the proposed solution by giving it a rating on a scale (e.g., 1 to 10). The minimum configuration of the group comprises at least three members in addition to the problem expert. Additionally, a single individual can function both as the scribe and the facilitator. Optimally, these roles should be fulfilled by two individuals. Meetings conducted according to the disclosed method may be conducted either with or without the use of a computer to pace the meeting and to determine the order of business. The advantages of using a computer are that data proposed by the team may be stored in a database. Moreover, at the end of the session, the data can be retrieved in an organized and systematic manner to produce several important final reports.

### BRIEF DESCRIPTION OF THE DRAWINGS

FIG. 1 is a schematic diagram of the traditional team that meets to solve a problem.

FIG. 2 is a schematic diagram of the team that meets to solve a problem using the method of the Present Invention.

FIG. 3 is a schematic diagram of the smallest team that can meet to solve a problem using the method of the Present Invention.

FIG. 4 is a schematic diagram of the team that meets to solve a problem using the method of the Present Invention wherein a computer is used to pace the meeting and to determine the order of business.

FIG. 5 is a flowchart showing the basic steps of the method of the Present Invention. It spans five drawing sheets, i.e., FIG. 5(a)-FIG. 5(f).

FIG. 6 is a flowchart of a computer program developed to pace a meeting according to the Present Invention and to determine the order of business. It spans five drawing sheets, i.e., FIG. 6(a)-FIG. 6(e).

FIG. 7 is a schematic diagram of the database layout used in the computer program of FIG. 6.

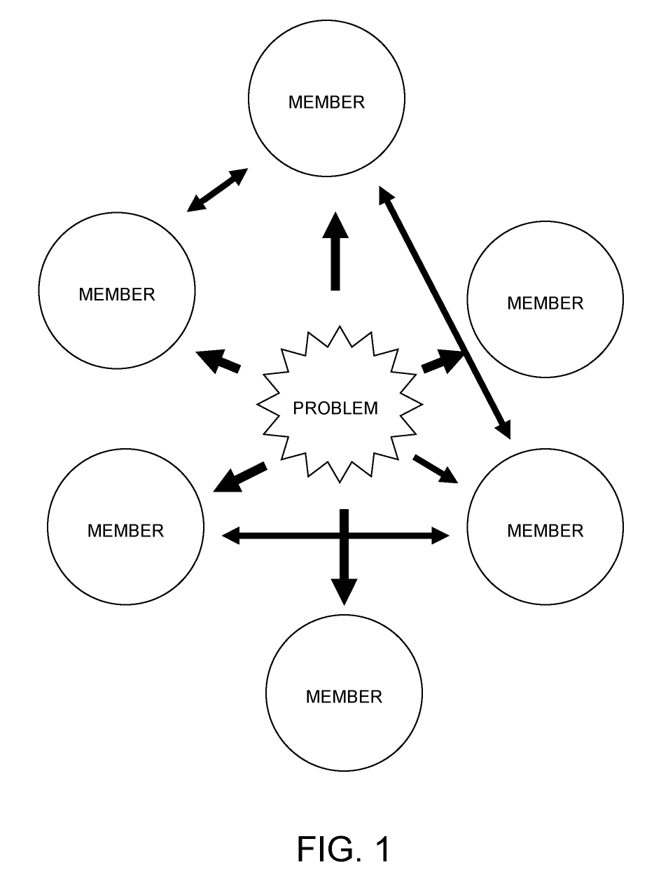

### DETAILED DESCRIPTION OF THE INVENTION

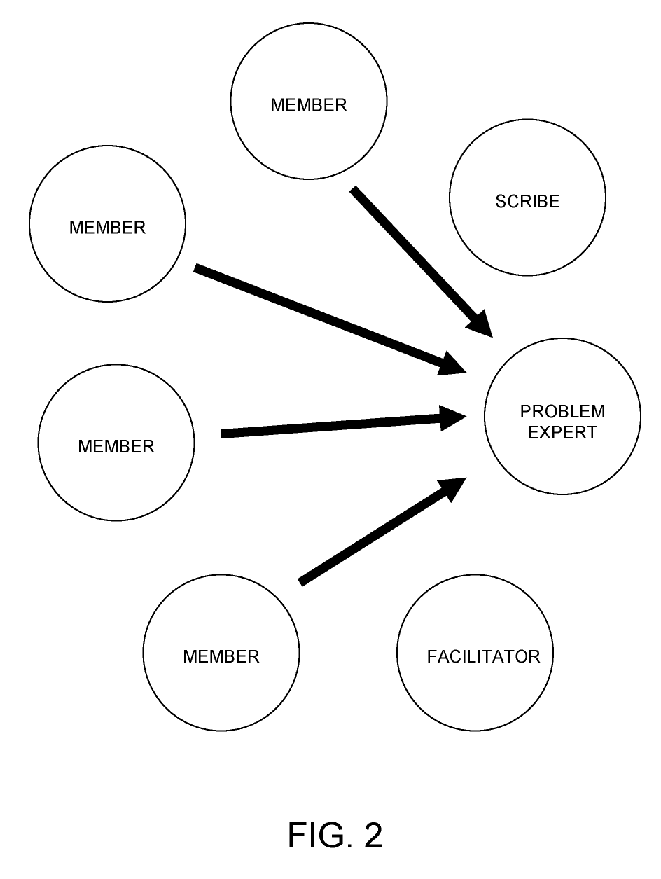

FIG. 2 is a schematic diagram illustrating the group dynamics of the method of the Present Invention. The group comprises Team Members and a Problem Expert. The Problem Expert is not the team leader. The Problem Expert does not participate in developing the solution to the problem. He or she is too close to the problem to be impartial. If this were not the case, the Problem Expert would have solved the problem earlier, and the meeting would not be necessary. Therefore, the Problem Expert is initially present as though he or she is a consultant to the group. He or she initially presents the problem details to the Team Members, and is available for questions from the Team Members, but is forbidden from commenting on a proposed solution until the Team Members agree that the solution is fully developed. Therefore, during development of a solution, only Team Members can offer strategies to accomplish the solution. The Facilitator does not participate in development of the solution, nor does he or she evaluate or otherwise comment on any solution presented by the group. The Facilitator's only function is to run the meeting and to make sure that the correct sequence of events is adhered to by the group. The Facilitator must be independent and must not have a stake in the outcome of the meeting. A preferred implementation is having the Facilitator, who understands the functionality of the process, be an outside consultant to the group. Finally, a Scribe is present at the meeting to relieve the other participants from the burden of writing down the necessary data required at various stages of the meeting. The Scribe's function is purely secretarial. So, the meeting belongs to the Team Members who must all have equal opportunities to contribute ideas or strategies. Once a solution has been developed, the Problem Expert becomes a Team Member having equal status with the other Members. He or she now lends insight as to the viability of implementing the solution.

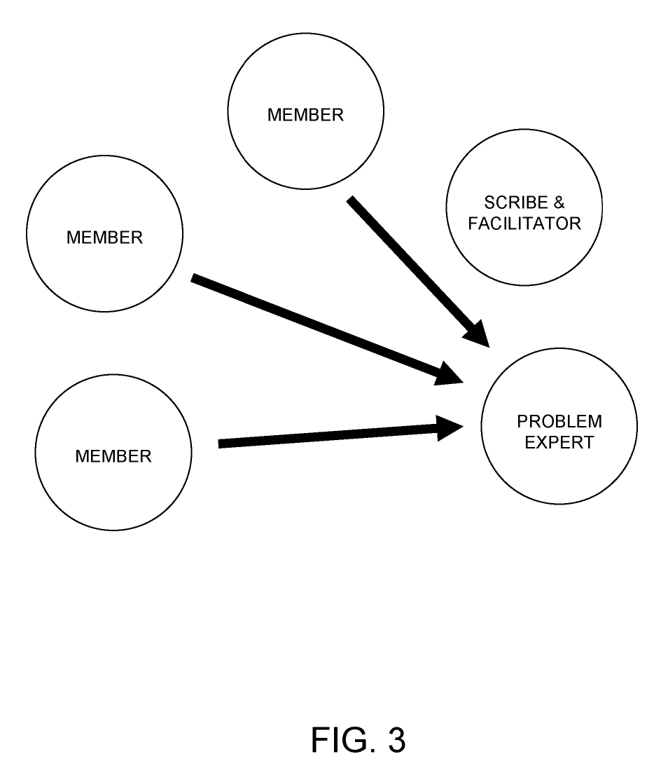

The question then arises as to what is the minimum number of people necessary for this method to be able to work properly. Clearly, there must be a Problem Expert. The Scribe and Facilitator can be the same person. However, how many Team Members are necessary to implement the method? If there is only one Team Member present, then there is no discussion or debate. The interplay is merely between the Problem Expert and the Member. This will not work. If there are only two Team Members present, then there is no mechanism to follow a given path if they disagree. However, if there are three Members present, then agreement by two of the three regarding how to proceed will allow the group to move forward. Therefore, the minimum configuration of the group would be a Problem Expert, three Members, and a person who acts both as Scribe and Facilitator. This five person meeting configuration is shown schematically in FIG. 3. Ideally, a group should have between six to eight Team Members to optimize input necessary to solve the problem.

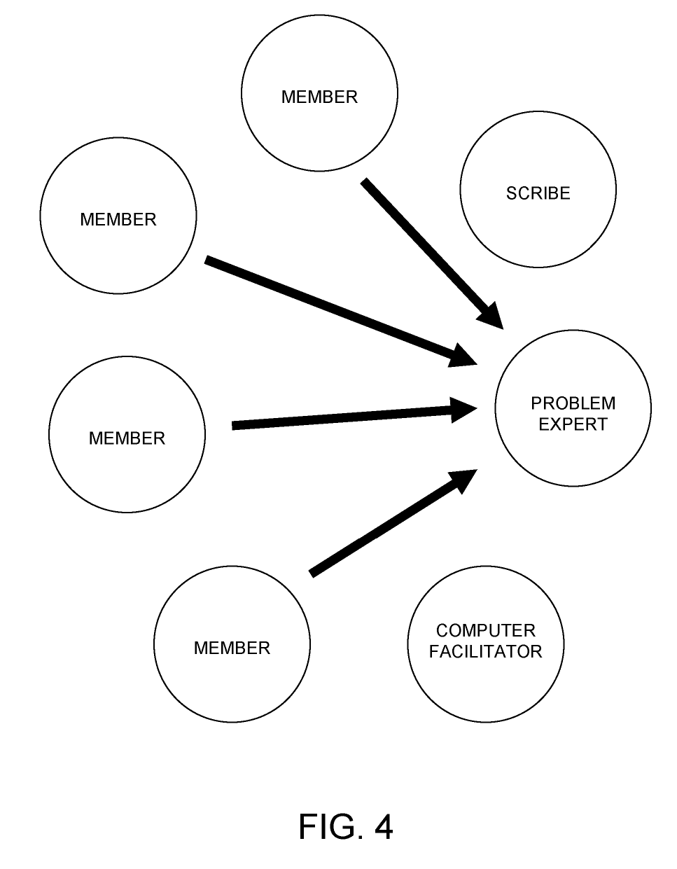

Experiments have shown that there is an advantage to using a computer during the meeting. At such times, the Computer Operator can be the Facilitator or the Scribe. The Facilitator is intimately familiar with the software which sequences the required order of events for the meeting. However, having separate people act as the Scribe and the Computer Operator has advantages. In this way, the Facilitator can concentrate on assuring that the Process is strictly adhered to. The computer meeting configuration is shown schematically in FIG. 4.

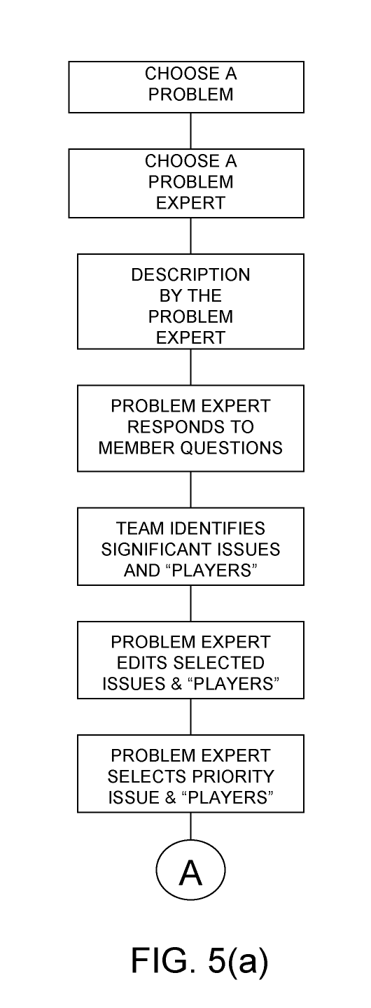

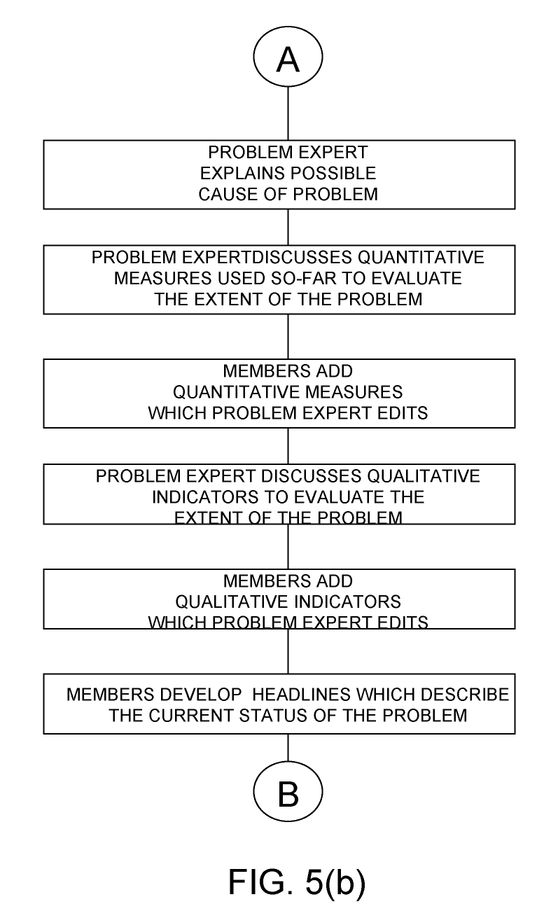

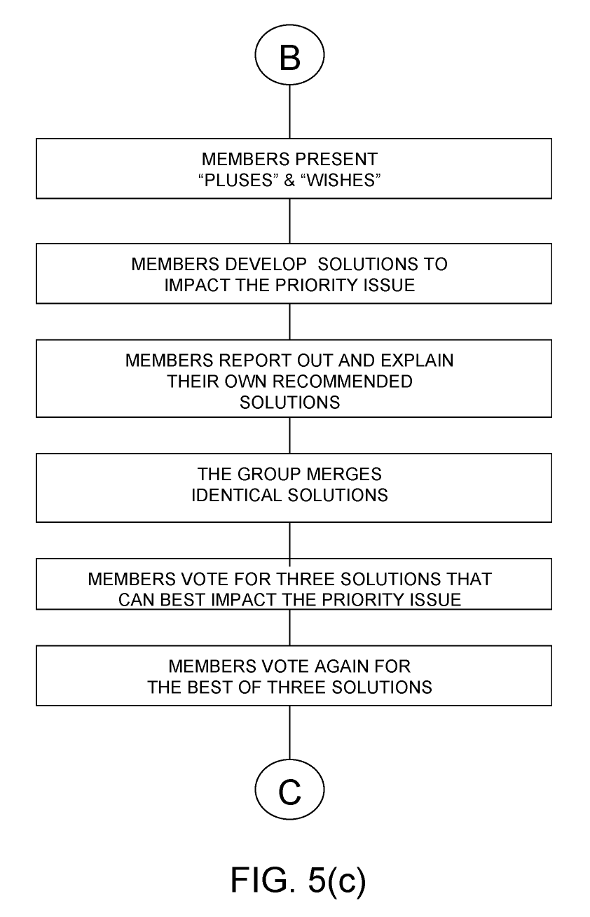

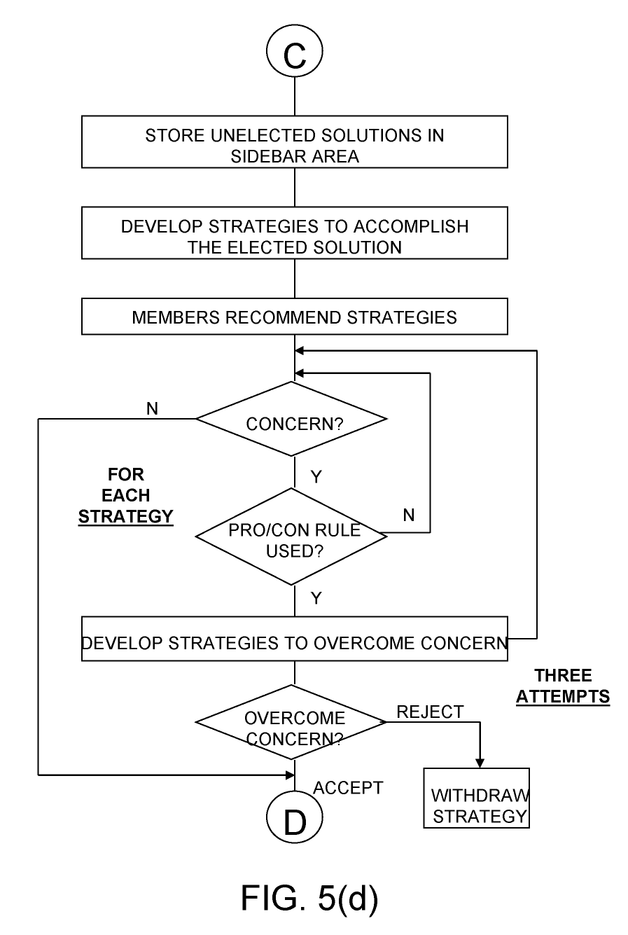

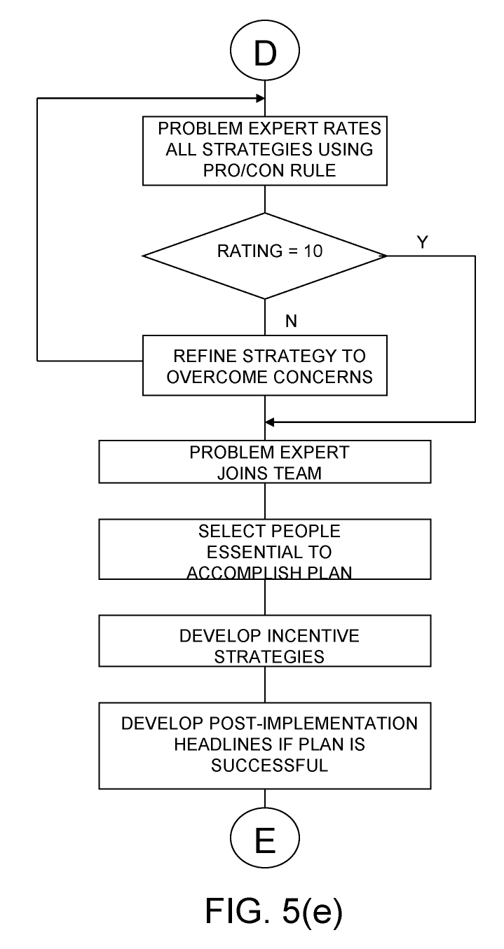

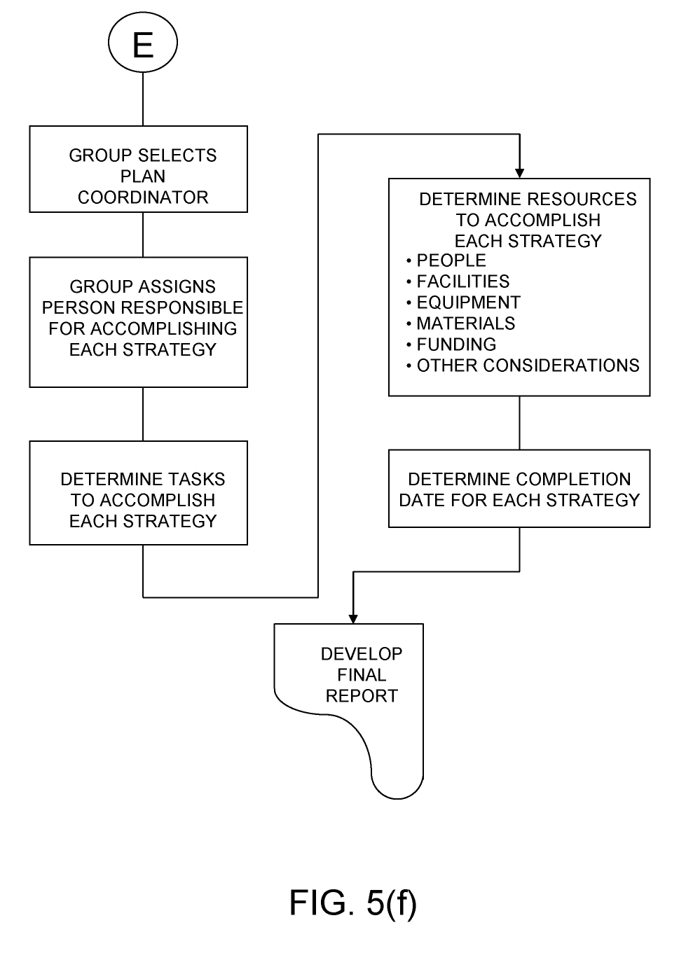

Now, the discussion turns to the actual method for solving the problem, said method being the subject of the Present Invention. Referring to FIG. 5(a), the first step is choosing a problem. This is done prior to the meeting. Top management of an organization must decide upon the problem to be solved since, within the organization, there may exist many problems. The next order of business is to decide which staff members are going to comprise the group, the main function of which is to solve the problem. The members of the group should be chosen from different disciplines and should possess a great deal of knowledge and experience with the selected problem. Best results are achieved when participants are company employees who are managers or division heads (e.g., marketing manager, public relations manager, head of training or staff development, etc.). It is also helpful to include one member from outside the organization who has knowledge and experience with the subject matter of the problem. Such an individual will not be limited or influenced by the organization's conventionally accepted ways of doing things. Thus he or she may be able to suggest different strategies that will be helpful in producing “out of the box” solutions.

When the group convenes, the first order of business is to identify the roles of the participants and to select a Problem Expert. Through group discussion, one participant is chosen to be the Problem Expert. The remaining participants now become Team Members having equal status. The Problem Expert is to be an expert on the problem, not on what solutions there may be to the problem. Criteria for selection of the Problem Expert are knowledge, experience, and investment in the problem selected. This would include knowledge of the history of the problem and what has been done about it.

The second order of business is analysis by the Problem Expert. The Facilitator directs the Problem Expert to present to the group with a detailed description of the problem. The Problem Expert must present the problem in specific (e.g., who, what, where, why, and how), and not global terms.

A global statement is one which is vague and lends itself to many different interpretations, and, therefore, produces confusion. If everyone is to have the same understanding, it is imperative that statements be made in specific and not global terms. A specific statement is one which provides information which is clearly and fully expressed. To be understood by everyone, a specific statement must be stated in terms which can be “seen and/or heard.” In this way, everyone will probably have the same interpretation. Everyone will be able to understand its use in the same way.

After the Problem Expert has completed his or her presentation, as the third order of business, the Team Members ask for clarification of the “picture” presented, if necessary. The Team Members are not allowed to ask the Problem Expert to make judgments. They may ask the Problem Expert whether he or she “sees” other things in the “picture.” The Problem Expert must respond to each question to the satisfaction of the member asking the question.

In the fourth order of business, the Members summarize the problem. This is done to insure that the Team Members and the Problem Expert see the same “picture.” At this stage, the Team Members give feedback to the Problem Expert as to how they view the problem in terms of significant issues and significant players relevant to the significant issues. The Facilitator must insure that the Members respond in visual terms. Significant issues can only be what is seen in the picture, not what is missing from the picture. Significant players can only be those individuals or groups that are seen in the picture. The process does not allow the Members to “fantasize.” Once this is complete, the Scribe records the feedback.

Following group feedback, the Problem Expert comments on the accuracy of the group feedback, correcting any misconceptions, and adding any other significant issues or players not mentioned by the Team Members. The Scribe then adds the significant issues and significant players identified by the Problem Expert, if any, which are missing from the list.

At this point, the Problem Expert identifies his or her top priority issue and significant players and, (see FIG. 5(b)). The Scribe records the top priority issue and players.

Referring to FIG. 5(b), in the next step, the Problem Expert describes what quantitative measures he or she used to determine the extent of the problem. If possible, the Expert should convey the number or percent used to determine the extent of the problem. The group now adds quantitative measures which should be used. The Program Expert then accepts, adds, modifies, or deletes the quantitative measures that the members propose.

Qualitative indicators are behaviors that can be seen or heard which indicate how people feel about themselves, one another, or things. Qualitative indicators are rarely given enough attention when analyzing company problems. The Problem Expert now discusses which qualitative indicators are appropriate. Once again, the members add qualitative indicators which the Problem Expert or group may edit. Once analysis by the Problem Expert is complete, the Problem Expert becomes an active listener.

Now, the Team Members are asked to fantasize about a newspaper story that would be written about the current problem. They are asked to contribute humorous headlines of the new stories to the group. A few examples are:
A baseball pitcher whose name was Victor lost a game. The headline was: “Fail to the Victor!”
A boat company reported poor profits. The headline was: “Sales not sailing!”
A coffee company also reported poor profits. The headline was: “Coffee company not perking!”

Referring to FIG. 5(c), the members discuss “pluses” and “wishes.” A plus is defined as something a member likes. A wish is defined as something the member would like to have occurred. The purposes of “pluses” and “wishes” is to obtain feedback as to how the group functions in following the process under the new system.

The Members are now asked to individually suggest one or two solutions to the problem which will impact the top priority issue, significant players as stated by the Problem Expert, which will produce changes as stated by the Problem Expert. They are to consider a solution which:
a) is innovative;
b) has not been tried before; and,
c) will highly motivate others.

Team Members may ask for clarification after each member completes his or her presentation of a suggested solution. Identical solutions are then combined so that each solution is unique.

At this point, the Members vote for three solutions. Each Member must distribute his or her vote for three different solutions. If there is a tie, the Problem Expert makes the selection. Now, the members vote again for the best solution. Each member is given three votes. This time, the Members may distribute their votes among one or more solutions. The solution with the most votes is chosen. Once again, in the event of a tie, the Problem Expert makes the selection.

It is important for everyone on the team to know that there is no way to determine which solution is the best. Therefore, the solution which received the highest number of votes will be the one chosen because it will produce the greatest energy from the group in attempting to solve the problem.

Referring to FIG. 5(d), all the solutions not used will be stored in a “sidebar area,” and will be retrieved in the final report document because they may be extremely valuable in the future. For now, the Members must focus upon the selected solution. The Member whose solution was selected is now asked once again, if necessary, to provide the group with a “snapshot” which clarifies the solution. The Scribe records the clarification.

If a Team Member has a concern regarding a suggested strategy, he or she must use the Pro/Con Rule. This is the first key rule. When a member of a team suggests a strategy to impact the solution to the problem, any other member who has a concern about the strategy, must first state something positive (pro) about it before expressing the concern (con). The required format of expression is:

“I like your idea because ______”

“My concern is ______”

If the Pro/Con rule was not used, a Team Member should raise his or her hand, and the Facilitator or Scribe must issue an alarm and require strict adherence to this rule. This will alert the person who raised the concern that it must be restated using the Pro/Con format.

An example of this is where there is a high rate of employee turnover in a company because employees feel isolated. The following strategy was recommended to improve the situation. It was proposed that a day should be set aside to have a picnic in the park with a variety of activities to increase the opportunities for interactions among employees. In this way, it was hoped that good will and more support for one another would result.

One person immediately said, “That's a poor idea because it might rain and no one will come.” This was a violation of the Pro/Con rule, and the person who made the statement was required to restate his concern using the proper format. He did so by saying, “I like your idea because a picnic in the park would be great fun and would promote friendship among the staff. My concern is that it may rain and few people would show up.”

This leads us to the second key rule: the process cannot be continued until an expressed concern is addressed and “overcome.” In this example, another person recommended, “We could overcome that concern by finding an indoor facility that could accommodate the events.” This strategy was accepted by the person who expressed the concern and the picnic was held.

In this way, the strategies are assessed. Then, more strategies are requested to address the needs expressed by the Problem Expert. Should a concern be voiced by a Team Member, the remaining Members must suggest strategies to overcome the concern. The person who voiced the concern must agree that the new suggestion overcomes the concern. If the new strategy is able to overcome the Member's concern, then that strategy is added to the plan. However, if after three attempts, the concern cannot be overcome to the satisfaction of the voicing Member, then the strategy must be withdrawn. If any concern cannot be overcome after three strategies are offered and rejected, then the strategy that caused the concern must be withdrawn. The session continues until at least six strategies are recommended.

Referring to FIG. 5(e), the Problem Expert now rates all the strategies recommended thus far. If the rating of the recommended strategies is less than “10,” the Problem Expert must use the Pro/Con rule to discuss the strategies.
“I like the strategies recommended because . . . However, the following concern needs to be addressed: . . . ”

The entire process is repeated until the Members believe that the plan is complete. The Problem Expert then rates all recommended strategies using a rating scale (e.g., from 0 to 10). If the strategies are given a rating less than the scale maximum, additional strategies are requested until the maximum rating is achieved. The plan is now complete. At this point, the Problem Expert joins the group with the same status as any other Member. Now, the team develops a list of people essential to accomplish the plan. A default list of essential people could include:
top management
other management personnel
other staff members
the customers
the shareholders
the sales staff.

Next, the entire group develops strategies designed to increase enthusiasm among the target population(s). These are extremely important since they are designed to highly motivate everyone who will be involved or affected by the plan. In this way, the probability of success is greatly increased. Some examples are: privileges and special awards, time off, vacations, bonuses, raises in salary, etc.

Once the plan is in place, the team is then asked to fantasize about post implementation news stories, and to develop newspaper headlines therefor. The post implementation headlines are compared with the initial headlines developed earlier. When the plan is successful, doing this provides a sense of accomplishment among the team members.

Referring to FIG. 5(f), the group assigns responsible individuals to have authority to accomplish each strategy. Usually, these individuals will be participants in the group, but this is not necessarily the case. A coordinator is selected to monitor the plan and to whom all strategies are to be reported upon their completion. The Coordinator need not be a member of the team.

Finally, for each strategy, the following information must be obtained in order to systematically accomplish each strategy:
Who is responsible for completion of this strategy?
How is it to be accomplished? (Tasks)
What resources are needed to complete this strategy?
   [symbol] People needed
   [symbol] Facilities needed
   [symbol] Materials needed
   [symbol] Equipment needed
   [symbol] Funding needed
   [symbol] Completion Date
   [symbol] Other considerations.

The method described above has been implemented experimentally in an effort to properly reduce it to practice. During the experimental implementation period, extensive modifications were made to the method. One such modification was to add the use of a computer to the meeting. In this implementation, the sequence of steps for the method of the Present Invention appeared on screen shots that were visible to the entire group. One implementation is for a computer projector to be used. The Facilitator can be the computer operator. The Scribe can be a separate individual, or the Facilitator may also act as the Scribe. However, for a larger group, the Facilitator has very much to do while running the meeting, and a separate Scribe is necessary. In the preferred embodiment, the Scribe would use a computer for recording information in the database. However, where a computer was not available, the Scribe was able to use newsprint for recording purposes. The information recorded thereon can then be transferred to the computer database prior to production of the reports.

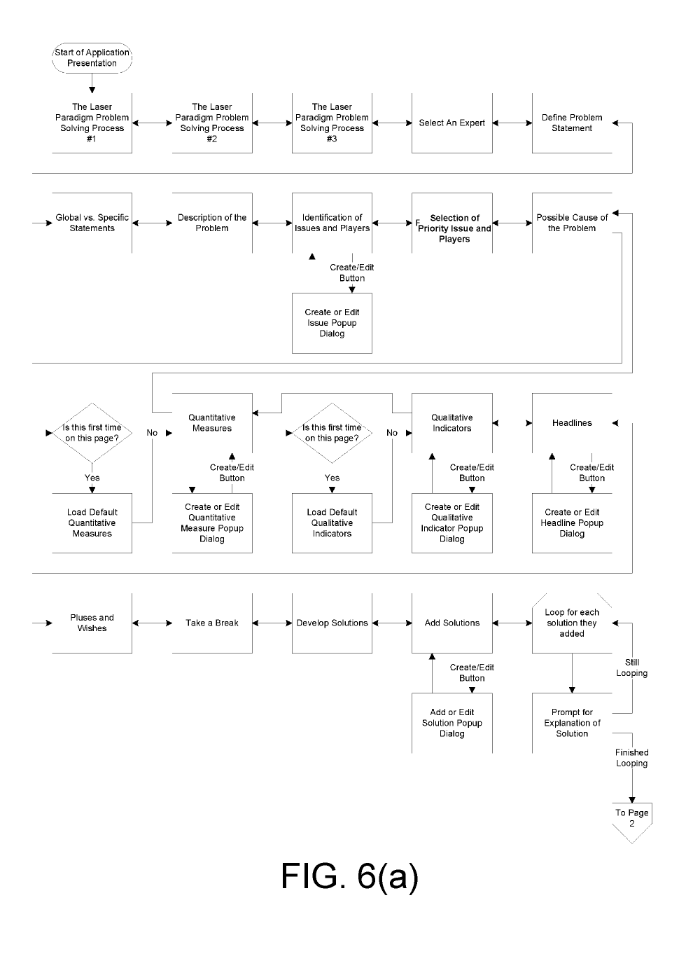

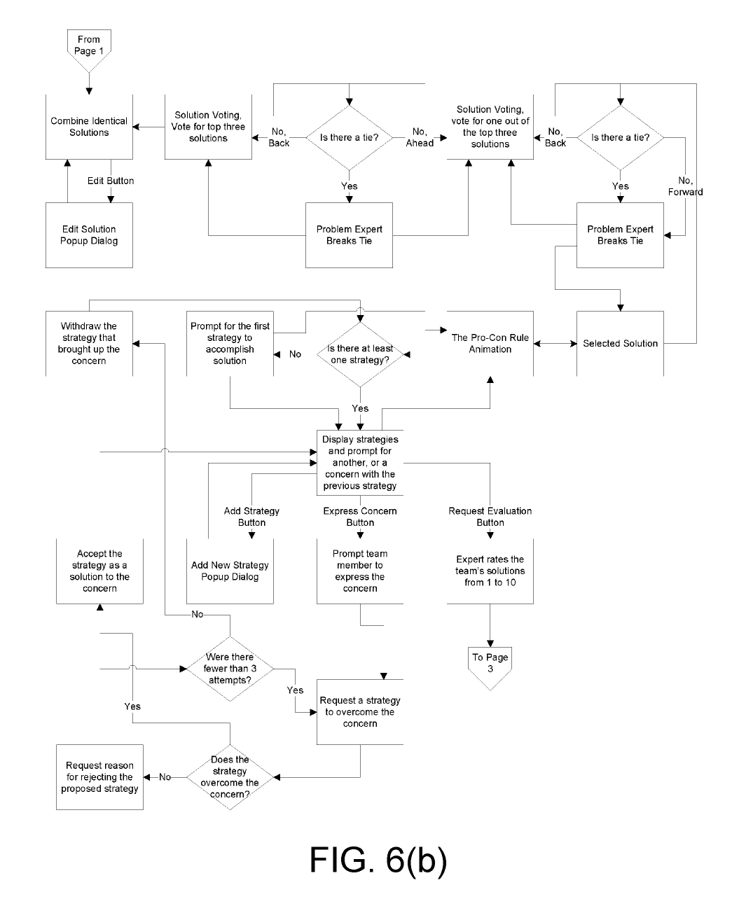

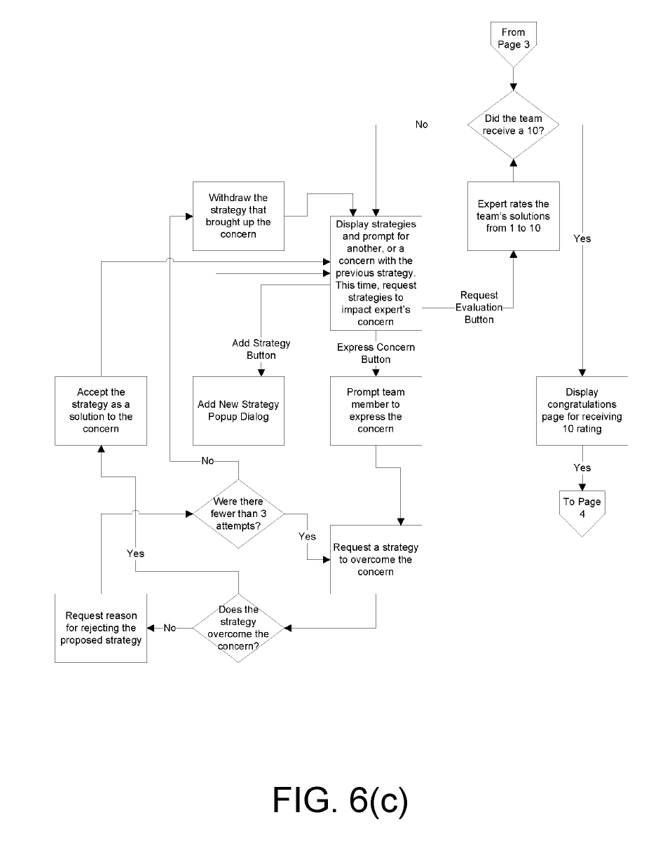

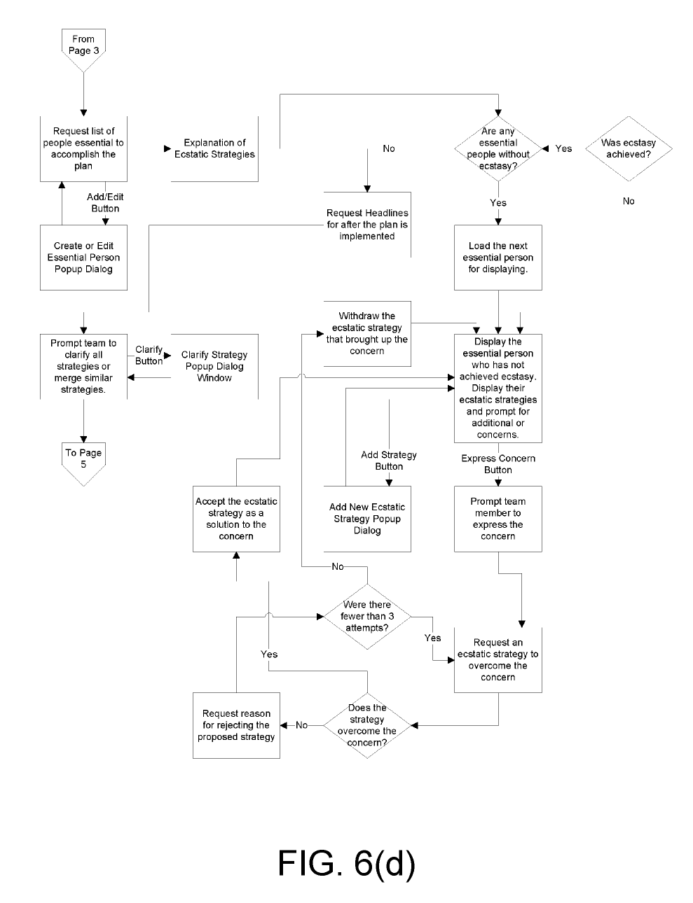

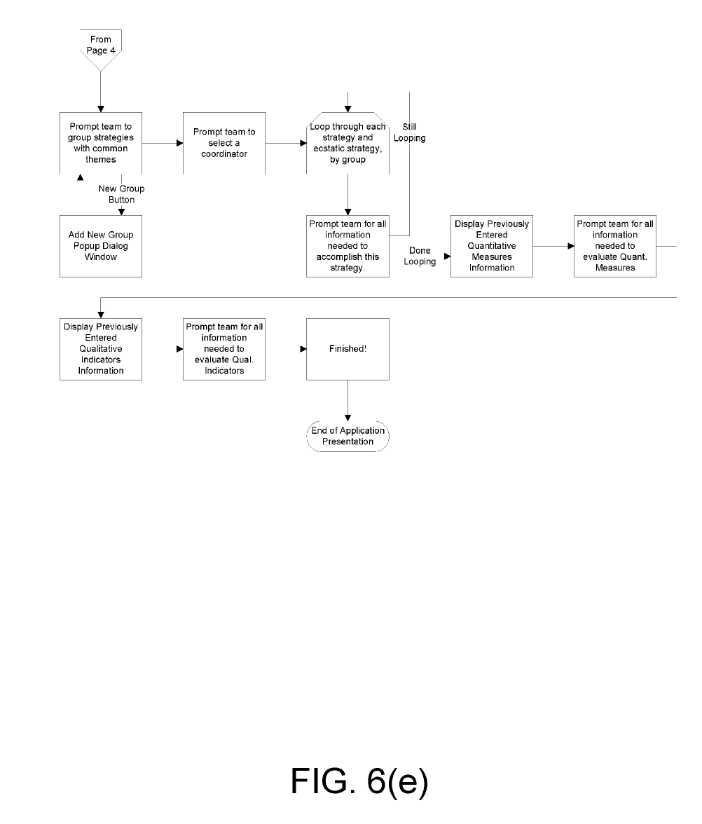

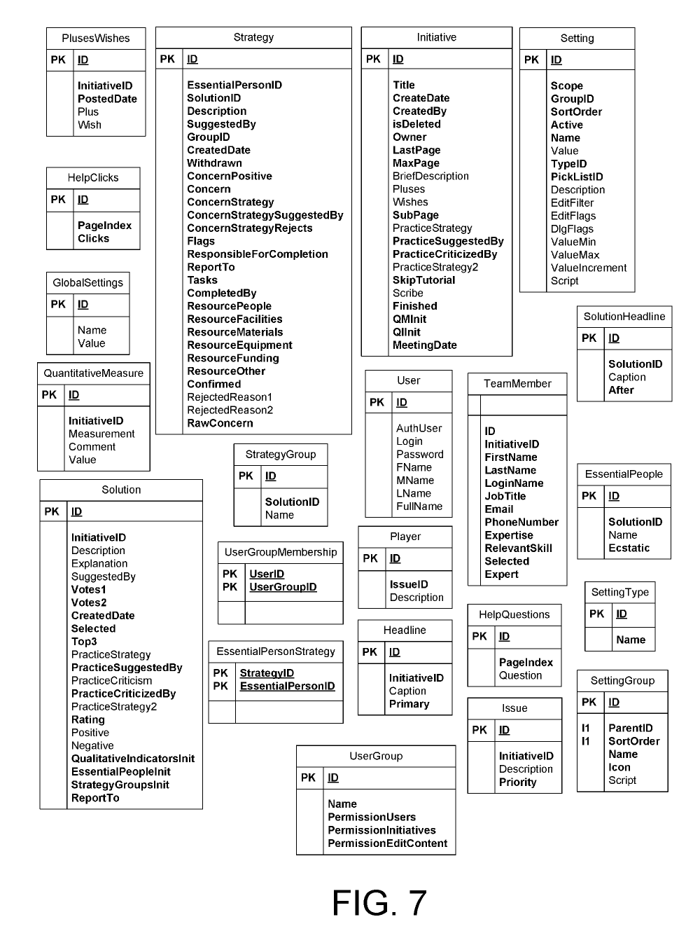

FIG. 6 illustrates a computer program flowchart for software that has been recently implemented to assist the Facilitator in conducting the meeting. In FIG. 6(a), the first three steps serve to make a presentation to the group using visual displays to describe the process to be used in the meeting. The process outlined therein is called the “Laser Paradigm Problem Solving Process.” The flowchart spans five drawing sheets, i.e., FIGS. 6(a) through (e). The program presents a series of screens that force each step in the method described using FIG. 5 to occur at the appropriate time. The author uses the term “ecstasy” to mean unqualified enthusiastic support. At various times, Members are asked to compose “headlines” to describe various input and output components. FIG. 7 illustrates the database layout for the “Laser Paradigm” program. The database follows a relational schema.

### SUMMARY OF THE METHOD OF THE PRESENT INVENTION

Select a group comprising at least three individuals with knowledge and experience in the substance of the problem and,

Provide a facilitator (human or machine) and a scribe (which may be the human facilitator).

Wherein:
The group designates one of the individuals as a problem expert.
The problem expert presents to the other individuals a description of the problem.
The other individuals propose solutions to the problem until at least three solutions are proposed.
The scribe memorializes the proposed solutions.
Each of the other individuals casts one vote for each of three of the proposed solutions.
The scribe causes the votes to be compiled and identifies the three proposed solutions having drawn the greatest number(s) of votes.
In case of a tie, the problem expert votes to break the tie.
Each of the other individuals (then) casts three votes, in any combination, for any of the three solutions.
The scribe causes the votes to be compiled and identifies the proposed solution having drawn the greatest number of votes.
In case of a tie, the problem expert votes to break the tie.
The other team members (then) suggest strategies to achieve the selected solution and, applying the pro-con rule, agree to propose a set of at least six strategies.
The set is proposed to the problem expert.
The problem expert responds with a scalar rating for the entire set.
If the rating is less than a target level of the scale, the problem expert applies the pro-con rule to express opinions of the proposed strategies.
The other individuals (then) suggest and propose new sets of strategies (which may include any or all of the members of the prior sets) and the problem expert rates each new set, until the target level is achieved.
   The facilitator may be a person or a computer. If the facilitator is a person, then the facilitator and the scribe may be the same person. A computer, if used, must enforce the Pro/Con Rule. The Problem Expert does not propose any solutions or strategies. The target level may be the maximum of the scale.
   Glossary
   The Pro/Con Rule—When a member of a team suggests a strategy to impact the solution to the problem, any other member who has a concern about the strategy, must first state something positive (pro) about it before expressing the concern (con).

1. A method for collaboratively solving a problem, comprising:
a) selecting a group comprising at least three individuals with knowledge and experience in the substance of the problem; and,
b) providing a human or electronic machine facilitator and a scribe who may be the human facilitator;
wherein:
the group designates one of the individuals as a problem expert;
the problem expert presents to the other individuals a description of the problem;
the other individuals propose solutions to the problem until at least three solutions are proposed;
the scribe memorializes the proposed solutions;
each of the other individuals casts one vote for each of three of the proposed solutions;
the scribe causes the votes to be compiled and identifies the three proposed solutions having drawn the greatest number of votes;
in the event of a tie, the problem expert votes to break the tie;
each of the other individuals then casts three votes, in any combination, for any of the three solutions;
the scribe causes the votes to be compiled and identifies the proposed solution having drawn the greatest number of votes,
in the event of a tie, the problem expert votes to break the tie;
the other individuals then suggest strategies to achieve the selected solution and, applying the pro-con rule, agree to propose a set of at least six strategies;
the set is proposed to the problem expert;
the problem expert responds with a scalar rating for the entire set;
if the rating is less than a target level of the scale, the problem expert applies the pro/con rule to express opinions of the proposed strategies;
the other individuals then suggest and propose new sets of strategies (which may include any or all of the members of the prior sets), and the problem expert rates each new set, until the target level is achieved.

2. The method of claim 1 wherein the facilitator is a person.

3. The method of claim 2 wherein the scribe and facilitator are the same person.

4. The method of claim 1 wherein the facilitator is a computer

5. The method of claim 4 wherein the computer enforces the pro/con rule

6. The method of claim 1 wherein the problem expert does not propose any solutions.

7. The method of claim 1 wherein the problem expert does not propose any strategies.

8. The method of claim 1 wherein the target level is the maximum of the scale.
